(19) United States
(12) Patent Application Publication
(10) Pub. No.: US 2002/0153982 A1
(43) Pub. Date: Oct. 24, 2002

(54) Electromagnetic actuator

(75) Inventors: Peter Jones, Balerna (CH); Aldo Reggiani, Origlio (CH)

Correspondence Address: OSTROLENK FABER GERB & SOFFEN, 1180 AVENUE OF THE AMERICAS, NEW YORK, NY, 100368403

(73) Assignee: R. Audemars SA

(21) Appl. No.: 09/838,423

(22) Filed: Apr. 19, 2001

(51) Int. Cl. H01F 7/08

(52) U.S. Cl. 335/220

(57) ABSTRACT

An electromagnetic micro actuator, e.g. for use in fiber optics, is operated by a ferromagnetic piston mounted within two electromagnetic coils inside a housing. The piston is held in place and magnetized by a plurality of permanent magnets. The coils are wired for opposite polarity and energizing the coils will tend to push the piston away from one coil and draw it towards another. A ceramic shaft attached to the piston protrudes from both ends of the micro actuator housing and moves with said piston. Energizing the coils thus moves the piston in one or the opposite direction depending on the current direction. Tapered jewel bearings guide the shaft with minimal friction.

### BACKGROUND OF THE INVENTION

1. Field of the Invention

The present invention relates to a micro actuator, particularly useful for optical switches, two electromagnetic coils moving a piston between two latched positions control the actuator.

2. Description of Related Art

In the field of fiber-optic communications, there is a need for electromechanical micro-actuated optical switches. The function of the switch is to direct/redirect laser beams from one channel to another within a maximum of time of 10 ms. These switches are typically electromechanical and operate by moving a mirror or filter to either permit or deviate passage of a laser beam through a gate. The switch toggles between two latched positions to operate as a binary switch. By placing the switches in a matrix coupled by fiber-optic collimators, it is possible to control the passage of information through the matrix. Due to the limited distance through which a laser beam can travel in free space between two collimators, it is desirable to make the switch as small as possible. A smaller switch design permits configuring more switch devices to form a single matrix of switches. Switch matrices can in turn also handle more switches, thereby permitting the design of more sophisticated gates.

However, current micro actuator design places limits on switch size reductions. Current micro actuators that produce a linear movement typically have a casing size of 11 mm in length with a 2 mm stroke. Permanent magnets are commonly arranged at opposite ends of the coils to hold a moving element in place when the micro actuator is not energized. This requires space to prevent interference between the two different magnetic fields created by the two permanent magnets. This need for separation effectively places a lower size limit on micro actuators with two permanent magnets. Moreover, current micro actuators may be subject to temperature and environmental fluctuations, particularly because they employ materials that can expand and contract due to temperature fluctuations.

### SUMMARY OF THE INVENTION

It is an object of the present invention to provide a smaller micro actuator that will maintain performance and reliability despite being of smaller size. It is a further object of the present invention to permit the micro actuator to be scaled down properly, reduce switching time to maximum 5 ms and as a final object to also enhance reliability by the selection of low friction and low thermal expansive materials.

The present invention uses a ferromagnetic piston that is situated inside two preferably identical electromagnetic coils that are mounted coaxially within a housing. The coils both encircle the piston. The piston is axially longer than each individual coil but shorter than their combined length. A set of radially magnetized permanent magnets encircle the center of the casing, magnetizing the ferromagnetic piston as well as holding the piston at one end or the other when the coils are not engaged.

A ceramic rod or shaft is attached to and extends through the piston so that it moves along with the piston. The rod or shaft moves a mirror or filter in one application of this micro actuator. The shaft protrudes through both ends of the device housing. Reciprocating motion of the shaft and the piston is guided by a respective jewel bearing mounted at each end of the housing. The jewel bearings, which are mounted within a seat that is outside of the housing, are cut with a tapered hole to fit the shaft and to reduce the friction between the shaft and jewel bearing.

The micro actuator is operated by energizing the two electromagnetic coils. The coils are wired and/or are so electrically connected and polarized that each generates an opposite directed magnetic field. The ferromagnetic piston is situated in one of the two end positions, held by the permanent magnets. Energizing the coil at one end of the housing where the piston is then located moves the piston out of that coil, while the other energized coil attracts the piston into the coil at the other end of the housing. This also reciprocatingly moves the shaft in the same direction of the piston. The coils may later be energized in the opposite polarity in order to move the piston and shaft in the opposite direction.

Other features and advantages of the present invention will become apparent from the following description of the invention, which refers to the accompanying drawings.

### BRIEF DESCRIPTION OF THE DRAWINGS

FIG. 1 is a longitudinal cross sectional view of a micro actuator constructed in accordance with a preferred embodiment of the present invention showing the piston of the actuator latched in one of its two positions.

FIGS. 1A and 1B show a close up of the bearings and shaft.

FIG. 2 is a cross sectional view of the micro actuator of FIG. 1 showing the piston of the actuator in the other of its two positions.

FIG. 3 is a perspective view, partially broken away, of the micro actuator of FIG. 1.

### DETAILED DESCRIPTION OF EMBODIMENTS OF THE INVENTION

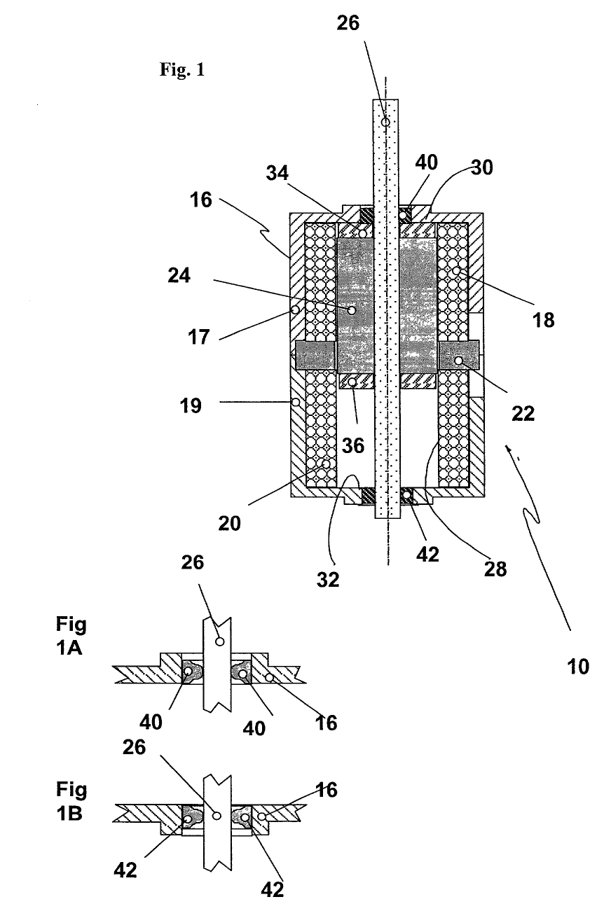

Referring now to the drawings, wherein like numerals indicate like elements, FIG. 1 shows a micro actuator according to the present invention. The presently preferred embodiment of micro actuator 10 may be used in an optical switch to control the direction of laser beams between two collimators (not shown). However, its use is not so limited. It can be used in any environment requiring a linear latched movement, especially one requiring a linear actuator of small size and fast switching time.

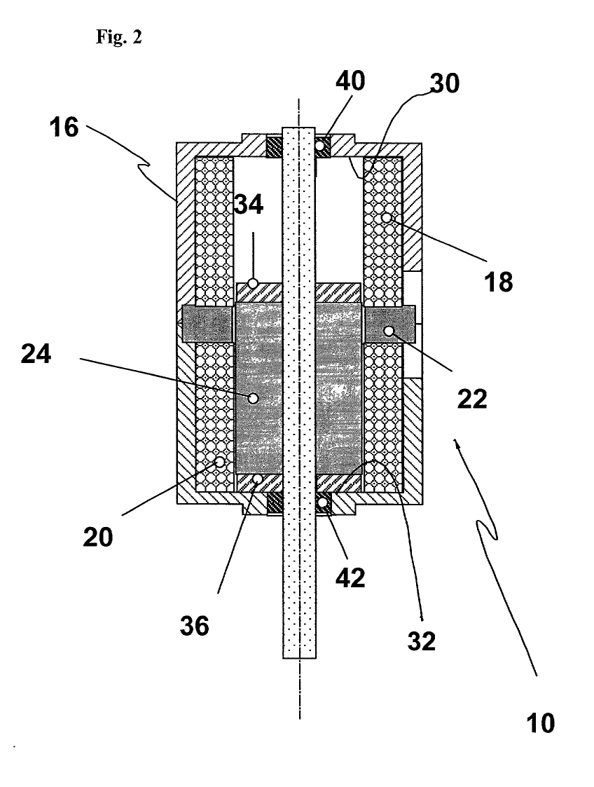

The micro actuator 10 includes a cylindrical housing 16, a pair of electromagnetic coils 18, 20 arrayed next to each other along the axis of the housing, a permanent magnet 22 placed between the coils and midway between the ends of the passage in the housing 16 and a piston 24 carried on a rod or shaft 26. The permanent magnet 22 and the electromagnetic coils 18, 20 cooperate to toggle the piston 24 between two latched positions, one to the top end of the passage in the housing 16 (shown in FIG. 1) and one to the bottom end of the passage in the housing 16 (shown in FIG. 2).

Housing 16 preferably comprises two separate castings 17 and 19 which are joined together in the center of the micro actuator 10. Coils 18, 20 and permanent magnet 22 are housed within the housing 16 and define a cylindrical passage 28 through which cylindrical passage the piston 24 slides. The diameters of the piston 24 and passage 28 are different to provide a small clearance between them. The coils 18, 20 and the magnet 22 cooperate to move the piston 24, and with it the rod 26, between the two latched positions shown in FIGS. 1 and 2 in response to appropriate driving signals applied to the coils 18, 20.

The permanent magnet 22 serves two purposes. It cooperates with the coils 18, 20 to reciprocatingly move the piston 24 between its first and second latched end positions when a driving current is applied to the coils and the magnet 22 also latches the piston 24 in place axially once the driving current is removed. This can be understood with reference to FIGS. 1 and 2. When the piston 24 is latched in the position against the top end of the passage in the housing, as shown in FIG. 1, at this time, no driving current is being applied to the coils 18, 20, and the ferromagnetic piston is held in place by the magnetic field generated by the permanent magnet 22. In order to move the piston 24 into the second latched position of FIG. 2, appropriate driving currents are applied to the coils 18, 20. The polarity of the currents is determined by the direction in which the piston 24 is to be moved, to the bottom from the position in FIG. 1, by the direction that the coils are wound and by the polarity of the electrical connections to the coils. Based on the foregoing consideration, a driving current is applied to the top coil 18 to generate a magnetic force which is of the same polarity as the magnetic field induced in the piston 24 by the permanent magnet 22. This creates a repulsive force which will urge the piston 24 to move to the bottom. At the same time, a driving current is applied to the bottom coil 20 to generate a magnetic force which is of opposite polarity to the polarity of the magnetic force induced in the piston 24 by the permanent magnet 22. This creates an attraction force which urges the piston 24 to the bottom. These two forces quickly move the piston 24 to the second latched position shown in FIG. 2 against the bottom end of the passage in the housing. After the piston 24 reaches the second latched position shown in FIG. 2, the driving currents are removed from the coils 18, 20 and the permanent magnet 22 locks the piston 24, and with it the rod 26, in the second latched position. When the piston 24 is to be returned to the first latched position, appropriate currents, whose polarity is opposite those applied to move the piston 24 to the bottom, are applied to the coils 18, 20. An appropriate control circuit connected to the coils is used to generate the driving signals for the coils and to control the timings of those signals.

In most applications, the micro actuator 10 should have a fast response time of less than 5 ms. Piston 24 moves quickly between its opposite latched positions. The momentum build up by the movement of the piston 24 may be sufficient to cause the piston 24 to rebound when it strikes the end walls 30, 32 or the housing 16 which define the opposite ends of the passage for the piston. To avoid this rebound and possible impact damage, cushioning gap rings 34, 36, formed of a force absorbing material such as neoprene, are provided on opposite longitudinal ends of the piston 24 to abut the end walls of the housing.

The length and position of the piston 24 within the passage 28 affects the magnetic forces applied to the piston 24 and therefore the characteristics of the micro actuator 10. Because the piston 24 is formed of a ferromagnetic material, the inductance value of the coils varies as a function of the extent to which the piston 24 is located within the coil. This value can vary by a ratio of as much as 3 to 1 as the piston 24 moves between its two opposite latched positions. When the piston 24 is located mostly within the coil 18, the inductance of the coil 18, as the magnetic force generated thereby, will be the highest. As the piston 24 moves towards the bottom as viewed in FIG. 1, it moves out of the coil 18 and into the coil 10 reducing the inductance of the coil 18 and the magnetic field generated thereby while increasing the inductance of the coil 10 and the magnetic field generated thereby. The opposite effect occurs when the piston moves from the second latched position shown in FIG. 2 back to the first latched position shown in FIG. 1. Controlling the length of the cushioning rings 34, 36 and the length of the piston 24, makes it possible to set the latch force with is required for a specific application. It is preferred that the length of the piston 24 be sufficient that it extends at least partially into both coils 18, 20 at all times, i.e., the piston is longer than each of the housing halves 17 and 19.

In one preferred embodiment, the tow coils 18, 20 are wired in parallel but wound in opposite directions so as to produce magnetic fields of opposite direction when current of the same polarity (direction) is applied to both coils. However, the invention is not so limited. For example, the coils 18, 20 may be wound in the same direction and currents of opposite polarity may be applied to the coils. Additionally, it is not necessary that driving currents be simultaneously applied to both coils 18, 20. A driving current can be applied to only one coil at a time and/or the degree of overlap of driving currents applied to the two coils can be varied.

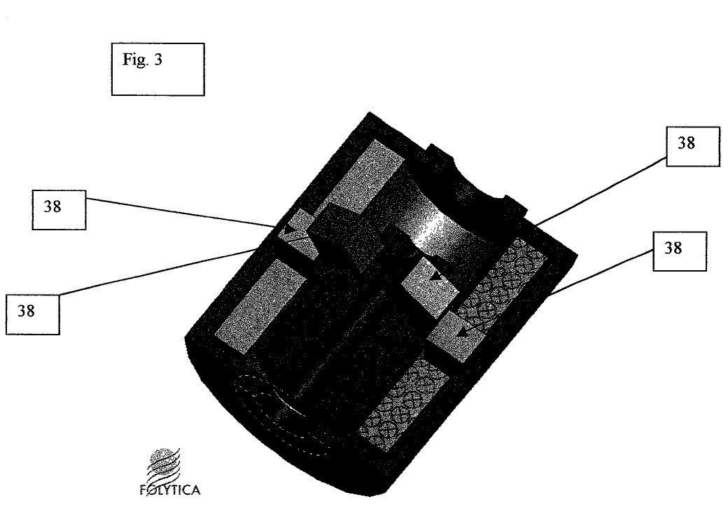

As shown in FIG. 3, the permanent magnet 22 is preferably formed of a plurality, e.g. five or six permanent magnets 38 formed of a material such as the Vacodym 510HR, which has a remnant inductivity of 1.41 T and a coercivity of 980,000 A/m. These permanent magnets are radially magnetized and are evenly arrayed around the circumference of the housing 16. The permanent magnets 38 may be mounted in a holding member (not shown) of a non-magnetic material.

The rod 26, which is preferably formed of a low friction, non-ferromagnetic material, such as a ceramic, extends through a pair of bearings 40, 42 located in respective openings formed in the longitudinal end walls of the housing 16. The bearings are preferably formed of a jewel bearing material, such as corundum, artificial corundum or any other artificial ruby of sapphire. In the case of both rod and bearings, it is preferable to select materials that will have less than a 10° m variance from 40° C. to 80° C. The bearings 40, 42, are tapered, as shown in FIGS. 1A and 1B, to reduce the friction between bearings or shaft.

One advantage of the present invention is that the variable inductance of the coils 18, 20, due to the movement of the piston 24 into and out of the coils, can be used to determine the instantaneous position of the piston 24 and therefore of its rod 16. To this end, by comparing the inductance of each coil 18, 20 will determine which coil contains the piston 24.

Dimensions and operating characteristics of an example of a microactuator according to the invention are now described. To establish context for this invention, known microactuators which produce a linear movement have a casing typically on the order of 11 mm in length and about 6 mm diameter, a stroke of 2 mm, a switching time of typically 10 ms and a shaft of steel.

For a microactuator according to the present invention, the casing length may be 5 mm with a stroke of 1 mm or may be 6 mm with a stroke of 2 mm. Casing lengths of 7 mm or 9 mm are possible. In either example, the casing has a diameter of about 4 mm and specifically 3.9 mm, but it may be up to 5 mm. Because the shaft may be comprised of a ceramic material and the bearing of the shaft may be a jewel bearing or the like, there is almost no thermal expansion or contraction. The transversal guidance has a precision of about 1 μm, for example, from −40° C. and 80° C.

The wire coil in each of the electromagnets hat 454 turns of a wire of 35 μm. The coil has a diameter of 3.1 mm. There is a power dissipation of 950 mW @ 5V and a coil current of 0,095A when the coils are connected in parallel. When the switch path is 2 mm, the supply voltage would be 5 volts. The current at the maximum would be 0,250 amps. The square wave impulse time would be 10 ms and the switch path is achieved in 5 ms. The latching force at both ends is >30 mN without any applied voltage.

The forgoing parameters are for an example and not are intended to limit the scope of the invention.

Although the present invention has been described in relation to particular embodiments thereof, many other variations and modifications and other uses will become apparent to those skilled in the art. It is preferred, therefore, that the present invention be limited not by the specific disclosure herein, but on by the appended claims.

What is claimed is:

1. An electromagnetic actuator comprising:
a housing with two opposite ends;
a piston comprised of ferromagnetic material, said piston being located in said housing and axially moveable between firs and second positions along a reciprocating path in said housing;
a pair of electromagnetic coils surrounding said piston, said coils being arrayed one after the other along said reciprocating path of said piston, said coils being operable to reciprocatingly move said piston along said path with one said coil being operable to repel said piston to move in one direction and the other said coil being operable to attract said piston in said one direction, and vice versa;
and at least one permanent magnet located axially between said pair of electromagnetic coils, said at least one permanent magnet having a magnetic field with a strength for latching said piston inplace when said electromagnetic coils are not energized and for permitting said piston to move between said first and second positions when at least one of said coils are energized.

2, The electromagnetic actuator of claim 1, further including of shaft coupled to said piston for movement with said piston and extending axially of said piston and outside of said housing.

3, The electromagnetic actuator of claim 1, wherein said shaft is comprised of a ceramic material.

4, The electromagnetic actuator of claim 1, wherein said housing has two opposite passage ends and said piston has two opposite ends each opposing a respective said passage end of said housing.

5, The electromagnetic actuator of claim 4, further comprising a gap ring attached to at least one said end of said piston for abutting the respective opposed said passage end where said piston moves toward the once said passage end.

6, The electromagnetic actuator of claim 5, further comprising a respective said gap ring attached to the other end of said piston for abutting the respective opposed said passage end where said piston moves toward the opposite said passage end.

7, The electromagnetic actuator of claim 5 wherein said gap ring is comprised of a cushioning material, for cushioning impact of said piston end with said passage end.

8, The electromagnetic actuator of claim 1, wherein said electromagnetic coils are in said housing.

9, The electromagnetic actuator of claim 8, wherein said electromagnetic coils are cylindrical coils which are coaxial with said reciprocating path.

10, The electromagnetic actuator of claim 9, wherein said piston is cylindrically shaped having an outer radius and said electromagnetic coils have an inner radius which is larger than said outer radius of said piston.

11, The electromagnetic actuator of claim 1, wherein said piston and said housing are coaxial.

12, The electromagnetic actuator of claim 1, wherein said housing has opposite passage ends between which said piston path extends and said at least one permanent magnet is located at the axial center of said housing and between said passage ends.

13, The electromagnetic actuator of claim 1, wherein said piston is of greater axial length than the axial length either of said coils, thereby preventing the piston from being completely surrounded by either of said coils.

14, The electromagnetic actuator of claim 1, wherein said at lease one permanent magnet comprised a circumferential array of a plurality of permanent magnets surrounding said piston.

15, The electromagnetic actuator of claim 14, wherein said permanent magnets are radially magnetized.

16, The electromagnetic actuator of claim 14, further comprising a respective carrier of plastic non-magnetic material in which each of said permanent magnets is mounted.

17, The electromagnetic actuator of claim 14, further comprising magnet slots located in said housing in which said permanent magnets are mounted.

18, The electromagnetic actuator of claim 1, wherein a first one of said pair of coils and a second one of said pair of coils are respectively connected to different electric circuits, thereby allowing said first and second coils to have different driving currents and thus different inductances, for causing said piston to move toward said coils of greater inductance.

19, The electromagnetic actuator of claim 1, wherein said first coil and said second coil are wound in the opposite directions but wired in parallel, causing one coil to attract said piston and said other coils to repel said piston.

20, The electromagnetic actuator of claim 1, wherein said first coil and said second coils are wound in the same direction but wired to circuits of opposite polarity, causing one coil to attract said piston and said other coil to repel said piston.

21, The electromagnetic actuator of claim 2, wherein said shaft is longer axially than said housing, and protrudes from said opposite ends of said housing.

22, The electromagnetic actuator of claim 21, further comprising a respective bearing mounted at said opposite ends of said housing so that said shaft protrudes through said bearings.

23, The electromagnetic actuator of claim 22, wherein each said bearing is selected from the group consisting of jewel bearing material, corundum and artificial corundum.

24, The electromagnetic actuator of claim 21, wherein each said bearing tapers in the radial direction around said shaft, thereby reducing the friction between said shaft and said bearing.

25, The electromagnetic actuator of claim 23, wherein said bearing has a circular shape opening through which said shaft extends.

26, The electromagnetic actuator of claim 1, wherein each said coil with separate lead wires can be used to determine the inductance present in each of the coils at ay give time, which in turn determines the position of the piston relative of the two coils.

27, The electromagnetic actuator of claim 2, wherein said housing has to opposite passage ends between which said piston path extends;
said at least one permanent magnet is located at the axial center of said housing and between said passage ends;
said piston has two opposite ends each opposing a respective said passage end of said housing;
said electromagnetic coils are cylindrical coils which are coaxial with said reciprocating path and are in said housing;
said piston is cylindrically shaped and has an outer radius, said electromagnetic coils have an inner radius which is larger than said outer radius of said piston;
said housing has opposite passage ends.

28, The electromagnetic actuator of claim 27, wherein said housing has a length of 5 mm or 6 mm and has a diameter of about 4 mm.

29, The electromagnetic actuator of claim 28, wherein said piston has a switch path of 2 mm; said coils have a supply voltage of 5 volts and a maximum current of 0,250 amps.

30, A method for electromagnetic actuation using a plurality of coaxial electromagnetic coils each having two opposite ends, a two-ended ferromagnetic piston located inside said coils, and a permanent magnet.
the method comprising the following steps:
a. magnetizing said piston so that one end has one magnetic pole and the other has the opposite magnetic pole;
b. aligning said piston so that a first end of said magnetized piston is aligned with a fist of said coils;
c. energizing said first coil so that its magnetic field will repel said magnetized end of said piston that is aligned with said end of said first coil; and,
d. energizing said second coil to that its magnetic field will attract said second end of said magnetized piston, thereby causing said magnetized piston to move towards said second coil.

31, The method for electromagnetic actuation as give in claim 26, wherein said piston is magnetized by a series of permanent magnets mounted radially around said piston.
